(19) United States
(12) Patent Application Publication
(10) Pub. No.: US 2022/0235607 A1
(43) Pub. Date: Jul. 28, 2022

(54) RAIL CLIPS FOR STOWING A TILT WAND AND RELATED HEADRAIL ASSEMBLIES AND COVERINGS

(71) Applicant: Levolor, Inc., Atlanta, GA (US)

(72) Inventor: Justin Zhu, Lawrenceville, GA (US)

(21) Appl. No.: 17/583,698

(22) Filed: Jan. 25, 2022

Related U.S. Application Data
(60) Provisional application No. 63/141,561, filed on Jan. 26, 2021.

(51) Int. Cl. E06B 9/38; E06B 9/307

(52) U.S. Cl. CPC E06B 9/38; E06B 9/307

(57) ABSTRACT

In one aspect, a headrail assembly for a covering for an architectural structure includes a headrail and a tilt wand coupled to the headrail. The tilt wand includes a proximal end and a distal end spaced apart from the proximal end. The tilt wand is movable relative to the headrail between an operating position at which the tilt wand is suspended relative to the headrail at the proximal end of the tilt wand and a stowed position at which a portion of the tilt wand extending between the proximal and distal ends of the tilt wand is supported relative to the headrail. In addition, the headrail assembly includes a rail clip configured to couple the tilt wand to the headrail when the tilt wand is at the stowed position. The rail clip includes retention structure configured to retain the portion of the tilt wand relative to the headrail.

### CROSS-REFERENCE TO RELATED APPLICATIONS

The present application is based upon and claims the right of priority to U.S. Provisional Patent Application No. 63/141,561, filed Jan. 26, 2021, the disclosure of which is hereby incorporated by reference herein in its entirety for all purposes.

### FIELD

The present subject matter relates generally to coverings for architectural structures and, more particularly, to rail clips for retaining a tilt wand of a covering at a stowed position relative to a headrail of the covering.

### BACKGROUND

Coverings with tiltable elements are well known in the industry. For example, a Venetian blind typically includes a headrail, a bottom rail, and a plurality of horizontally oriented slats supported between the headrail and the bottom rail via cord ladders. A tilt system is also provided in association with the blind for tilting the slats about their longitudinal axes between a horizontal or open position for permitting light to pass between the slats and a closed position, wherein the slats are substantially vertically oriented in an overlapping manner to occlude or block the passage of light through the covering. In many instances, the tilt system will include a tilt wand that hangs downwardly from the headrail to allow the user to adjust the tilt angle of the slats by rotating the tilt wand, which in turn rotationally drives a tilt rod coupled to the cord ladders.

With conventional Venetian blind arrangements, the tilt wand always remains suspended from the headrail in a vertical orientation. As a result, the tilt wand tends to block a portion of the view through the blind when the slats are tilted to their open positions. Additionally, with the blind raised to its fully retracted position to expose the adjacent window relative to which the blind is installed, the tilt wand blocks a portion of the view through the window. Such blocking of the view through the blind and/or the adjacent window is typically considered a disadvantage by consumers when contemplating the purchase of a wand-operated blind.

Accordingly, rail clips that allow a tilt wand to be retained at a stowed position relative to a headrail of an associated covering would be welcomed in the technology.

### BRIEF SUMMARY

Aspects and advantages of the present subject matter will be set forth in part in the following description, or may be obvious from the description, or may be learned through practice of the present subject matter.

In one aspect, the present subject matter is directed to a headrail assembly for a covering for an architectural structure. The headrail assembly includes a headrail and a tilt wand coupled to the headrail. The tilt wand includes a proximal end and a distal end spaced apart from the proximal end. The tilt wand is movable relative to the headrail between an operating position at which the tilt wand is suspended relative to the headrail at the proximal end of the tilt wand and a stowed position at which a portion of the tilt wand extending between the proximal and distal ends of the tilt wand is supported relative to the headrail. In addition, the headrail assembly includes a rail clip configured to couple the tilt wand to the headrail when the tilt wand is at the stowed position. The rail clip includes retention structure configured to retain the portion of the tilt wand relative to the headrail.

In another aspect, the present subject matter is directed to a covering for an architectural structure. The covering includes a headrail, a bottom rail spaced apart from the headrail, and a plurality of slats supported between the headrail and the bottom rail. The covering also includes a tilt system configured to adjust a tilt angle of the plurality of slats. The tilt system includes a tilt wand coupled to the headrail. The tilt wand including a proximal end and a distal end spaced apart from the proximal end. The tilt wand is movable relative to the headrail between an operating position at which the tilt wand is suspended relative to the headrail at the proximal end of the tilt wand and a stowed position at which a portion of the tilt wand extending between the proximal and distal ends of the tilt wand is supported relative to the headrail. In addition, the covering includes a rail clip configured to couple the tilt wand to the headrail when the tilt wand is at the stowed position. The rail clip includes retention structure configured to retain the portion of the tilt wand relative to the headrail.

In a further aspect, the present subject matter is directed to a rail clip for retaining a tilt wand of a covering in a stowed position, with the rail clip being configured in accordance with any of the embodiments described herein.

These and other features, aspects, and advantages of the present subject matter will become better understood with reference to the following Detailed Description and appended claims. The accompanying drawings, which are incorporated in and constitute a part of this specification, illustrate embodiments of the present subject matter and, together with the description, serve to explain the principles of the present subject matter.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a front view of one embodiment of a covering for an architectural structure in accordance with aspects of the present subject matter, particularly illustrating a tilt wand of the covering at both an operating position (indicated by the solid lines) and a stowed position (indicated by the dashed lines) relative to a headrail assembly of the covering;

FIG. 2 illustrates a perspective view of one embodiment of the headrail assembly of the covering shown in FIG. 1, particularly illustrating the tilt wand disposed at the stowed position relative to a headrail of the headrail assembly;

FIG. 3 illustrates another perspective view of the headrail assembly shown in FIG. 2 with a valance of the headrail assembly exploded away from the remainder of the headrail assembly;

FIG. 4 illustrates a cross-sectional view of headrail assembly shown in FIG. 2 taken about line 4-4;

FIG. 5 illustrates a perspective view of one embodiment of a rail clip for retaining a tilt wand at a stowed position relative to a headrail in accordance with aspects of the present subject matter;

FIG. 6 illustrates a left side view of the rail clip shown in FIG. 5;

FIG. 7 illustrates a right side view of the rail clip shown in FIG. 5;

FIG. 8 illustrates a top view of the rail clip shown in FIG. 5;

FIG. 9 illustrates a bottom view of the rail clip shown in FIG. 5;

FIG. 10 illustrates a front view of the rail clip shown in FIG. 5;

FIG. 11 illustrates a rear view of the rail clip shown in FIG. 5;

FIG. 12 illustrates a perspective view of another embodiment of a headrail assembly suitable for use with a covering in accordance with aspects of the present subject matter, particularly illustrating a tilt wand disposed at the stowed position relative to a headrail of the headrail assembly;

FIG. 13 illustrates a perspective view of another embodiment of a rail clip for retaining a tilt wand at a stowed position relative to a headrail in accordance with aspects of the present subject matter;

FIG. 14 illustrates a left side view of the rail clip shown in FIG. 13;

FIG. 15 illustrates a right side view of the rail clip shown in FIG. 13;

FIG. 16 illustrates a top view of the rail clip shown in FIG. 13;

FIG. 17 illustrates a bottom view of the rail clip shown in FIG. 13;

FIG. 18 illustrates a front view of the rail clip shown in FIG. 13; and

FIG. 19 illustrates a rear view of the rail clip shown in FIG. 13.

### DETAILED DESCRIPTION

In general, the present subject matter is directed to rails clips for retaining a tilt wand of a covering for an architectural feature or structure (referred to herein simply as an architectural “structure” for the sake of convenience and without intent to limit) at a stowed or storage position relative to a headrail. For instance, as will be described below, the tilt wand may, in several embodiments, be pivotable or movable relative to the headrail between an operating position (e.g., at which the tilt wand is suspended relative to the headrail in a substantially vertical orientation) and a stowed position (e.g., at which the tilt wand is supported relative to the headrail in a substantially horizontal orientation). In such embodiments, suitable retention structure of the rail clip may be configured to engage a portion of the tilt wand when it is pivoted upwardly toward the stowed position, thereby allowing the rail clip to support the tilt wand relative to the headrail at the stowed position. As a result, the tilt wand may be stowed away, for example, at a location adjacent to the headrail to provide a user of the covering a view through the covering and/or the adjacent architectural that is not partially blocked or occluded by the wand.

Additionally, in several embodiments, the disclosed rail clip may also be configured to support an adjacent valance of a headrail assembly relative to the headrail. For instance, in one embodiment, the rail clip may include suitable support structure for coupling the valance to the headrail. In such an embodiment, the rail clip may be configured to perform a dual function, namely supporting both the valance and the tilt wand (when at the stowed position) relative to the headrail.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

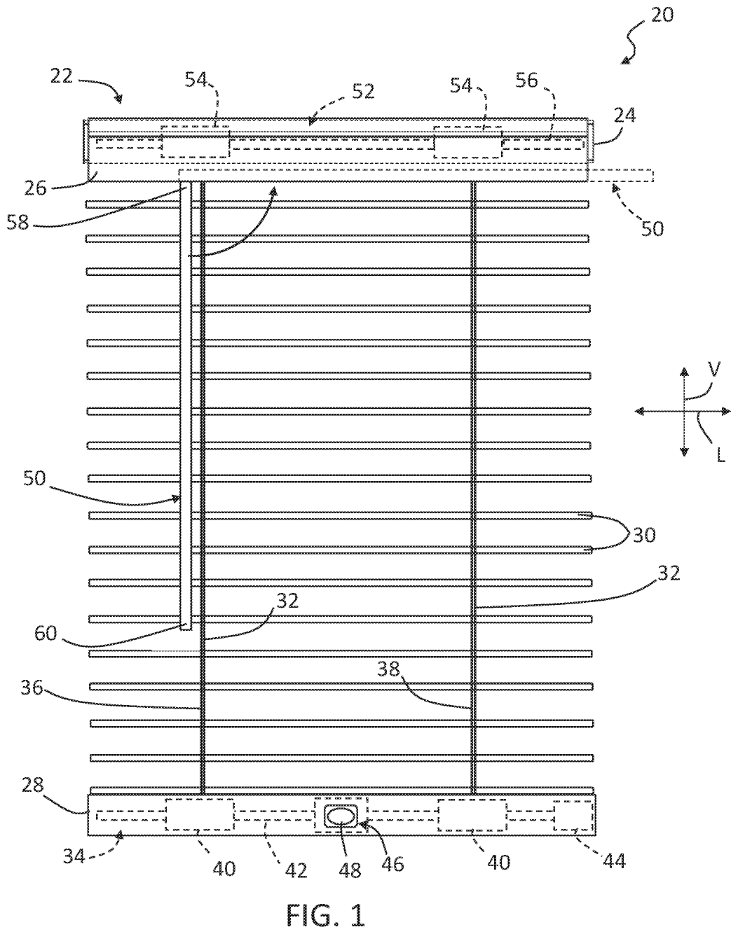

Referring now to the drawings, FIG. 1 illustrates a front view of one embodiment of a covering 20 for an architectural structure (not shown) in accordance with aspects of the present subject matter. In general, the covering 20 is configured to be installed relative to a window, door, or any other suitable architectural structure as may be desired. In one embodiment, the covering 20 may be configured to be mounted relative to an architectural structure to allow the covering 20 to be suspended or supported relative to the architectural structure. It should be understood that the covering 20 is not limited in its particular use as a window or door shade, and may be used in any application as a covering, partition, shade, and/or the like, relative to and/or within any type of architectural structure.

In several embodiments, the covering 20 may be configured as a slatted blind, such as a “privacy” Venetian-blind-type extendable/retractable covering. For example, in the embodiment shown in FIG. 1, the covering 20 includes a headrail assembly 22 and a bottom rail 28 supported relative to the headrail assembly 22. As shown in FIG. 1, the headrail assembly 22 includes a headrail 24 extending lengthwise in a lateral direction of the covering 20 (indicated by arrow L in FIG. 1) and a valance 26 configured to be installed relative to the headrail 24 so that the valance 26 generally extends laterally along the front of the headrail 24, thereby allowing the valance 26 to provide an aesthetically appealing façade or appearance to the headrail assembly 22. Additionally, the covering 20 includes a plurality of horizontally disposed, parallel slats 30 configured to be supported between the headrail 24 and the bottom rail 28 via one or more ladder tape assemblies 32 (e.g., a pair of ladder tape assemblies 32). In several embodiments, the slats 30 are rotatable or tiltable about their longitudinal axes by manipulating the ladder tape assemblies 32 to allow the slats 30 to be tilted between a horizontal or open position (e.g., as shown in FIG. 1) for permitting light to pass between the slats 30 and a closed position (not shown), wherein the slats 30 are substantially vertically oriented in an overlapping manner to occlude or block the passage of light through the covering 20.

Additionally, the covering 20 may also include a lift system 34 for moving the covering 20 in a vertical direction (indicated by arrow V in FIG. 1) between a lowered or extended position (e.g., as shown in FIG. 1) and a raised or retracted position (not shown). As shown in FIG. 1, the lift system 34 may include two or more pairs of lift cords (e.g., first and second pairs 36, 38 of front and rear cords), with each pair 36, 38 of lift cords being configured to extend to a corresponding lift station 40 to control the vertical positioning of the bottom rail 28 relative to the headrail 24. For instance, in the illustrated embodiment, each pair 36, 38 of lift cords is operatively coupled to a respective lift station 40 housed within the bottom rail 28. In such an embodiment, a bottom end (not shown) of each lift cord is configured to be coupled to its associated lift station 40 while an opposed end (not shown) of each lift cord is configured to be coupled to the headrail 24. For example, each lift station 40 may include one or more lift spools (e.g., a pair of lift spools) for winding and unwinding the respective lift cords. Thus, as the bottom rail 28 is raised relative to the headrail 24, each lift cord is wound around its respective lift spool. Similarly, as the bottom rail 28 is lowered relative to the headrail 24, each lift cord is unwound from its respective lift spool. Additionally, the lift system 34 of the covering 20 may also include a lift rod 42 operatively coupled to the lift stations 40 and a spring motor 44 operatively coupled to the lift rod 42. In such an embodiment, as is generally understood, the spring motor 44 may be configured to store energy as the bottom rail 28 is lowered relative to the headrail 24 and release such energy when the bottom rail 28 is being raised relative to the headrail 24 to assist in moving the covering 20 to its retracted position.

It should be appreciated that, in one embodiment, the spring motor 44 may be overpowered. In such an embodiment, to prevent unintended motion of the bottom rail 28 relative to the headrail 24, a brake assembly 46 may be provided within the bottom rail 28 and may be operatively coupled to the lift rod 42 to stop rotation of the lift rod 42. For instance, as shown in FIG. 1, to actuate the brake assembly 46, an actuator button 48 is coupled to the bottom rail 28 that can be depressed to release or disengage the brake assembly 46 from the lift rod 42, thereby allowing the lift rod 42 to be rotated in a manner that permits the lift cords to be wound around or unwound from their respective lift spools as the bottom rail 28 is lowered or raised, respectively, relative to the headrail 24. In other embodiments, the spring motor 44 may not be overpowered, thereby eliminating the need for the brake assembly 46. For example, in one embodiment, the spring motor 44 may be adapted to provide a variable torque, thereby allowing the lift system 34 to be configured as a balanced operating system.

Referring still to FIG. 1, in several embodiments, the ladder tape assemblies 32 of the covering 20 may be manipulated to allow for the slats 30 to be tilted between their open and closed positions using a tilt wand 50 of an associated tilt system 52 incorporated into or otherwise forming part of the headrail assembly 22′. For example, as shown in dashed boxes in FIG. 1, the covering 20 includes one or more components of the tilt system 52 within the headrail 24, such as a tilt station 54 provided in operative association with each ladder tape assembly 32 and a tilt rod 56 coupled between the tilt wand 50 and the tilt stations 54. In such an embodiment, as the tilt wand 50 is manipulated by the user (e.g., by rotating the tilt wand 50 relative to the headrail 24), the tilt rod 56 may be rotated to rotationally drive one or more tilt drums (not shown) of the tilt stations 54, thereby allowing front and rear ladder rails (not shown) of each ladder tape assembly 32 to be raised or lowered relative to each other to adjust the tilt angle of the slats 30.

In several embodiments, the tilt wand 50 may be configured to be movable or pivotable relative to the headrail 24 between an operating position (indicated by the solid lines) and a stowed position (indicated by the dashed lines). As particularly shown in FIG. 1, in the operating position, the tilt wand 50 is generally oriented up-and-down in the vertical direction V, with the wand 50 extending vertically from a proximal end 58 coupled to the headrail 24 to a distal or free end 60 spaced apart from the headrail 24. In other words, the tilt wand 50 is generally suspended relative to the headrail 24 from the proximal end 58 of the wand 50. As such, the tilt wand 50 generally extends vertically downwardly from the headrail 24 when in the operating position and blocks a portion of the view through the covering 20 when the slats 30 are tilted to their open positions. Additionally, with the covering 20 moved to its fully retracted position, the tilt wand 50 still extends downwardly from the headrail 24 when in the operating position and, thus, blocks a portion of the view through the adjacent architectural structure (e.g., the adjacent window relative to which the covering 20 is installed). In contrast, as shown in FIG. 1, in the stowed position, the tilt wand 50 is generally oriented horizontally (e.g., in the lateral direction L), with the wand 50 extending horizontally between its proximal and distal ends 58, 60 adjacent to the headrail 24. For instance, in one embodiment, the tilt wand 50 may be configured to be positioned behind a portion of the valance 26 when at the stowed position, thereby allowing the tilt wand 50 to be concealed or substantially concealed from view. Accordingly, the tilt wand 50 is generally positioned out of the field-of-view when at the stowed position, which provides an uninhibited view through the covering and/or the adjacent architectural structure. As will be described below, in several embodiments, one or more rail brackets or clips may be used to retain the tilt wand 50 at the stowed position. For example, the rail clip(s) may be configured to be coupled to the headrail 24 and may include suitable retention structure for retaining the tilt wand 50 at the desired position relative to the headrail 24 and/or the valance 26. For instance, the rail clip(s) may be configured to support the tilt wand 50 relative to the headrail 24 at one or more locations defined between the proximal and distal ends 58, 60 of the wand 50. Additionally, in some embodiments, the rail clip(s) may serve a dual function by being further configured to support or retain the valance 26 relative to the headrail 24.

It should be appreciated that the configuration of the covering 20 described above and shown in FIG. 1 is provided only to place the present subject matter in an exemplary field of use. Thus, it should be apparent that the present subject matter may be readily adaptable to any suitable manner of covering configuration.

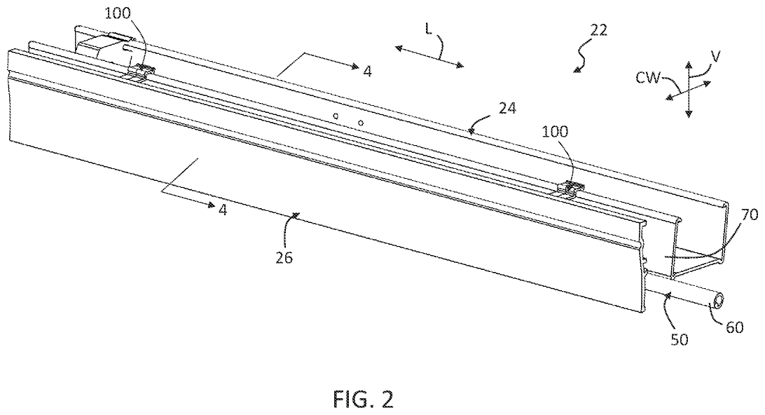

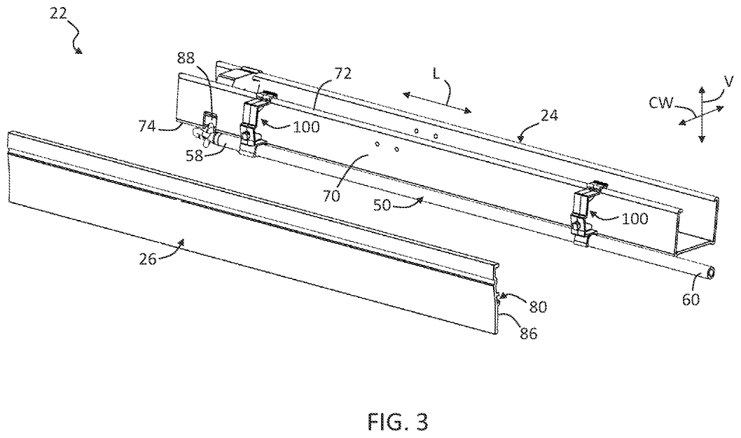

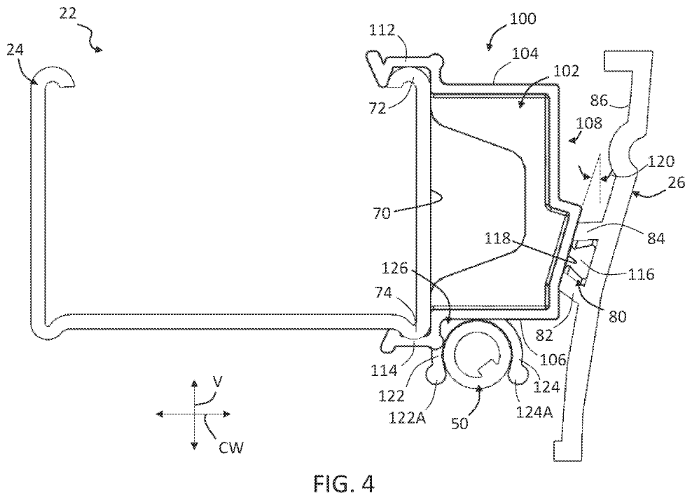

Referring now to FIGS. 2-4, several views of one embodiment of the headrail assembly 22 described above are illustrated in accordance with aspects of the present subject matter. Specifically, FIG. 2 illustrates a perspective view of the headrail assembly 22 with the tilt wand 50 disposed at the stowed position relative to the headrail 24, while FIG. 3 illustrates a similar perspective view as that shown FIG. 2 but with the valance 26 of the headrail assembly 22 exploded away from the headrail 24. Additionally, FIG. 4 illustrates a cross-sectional view of the headrail assembly 22 shown in FIG. 2 taken about line 4-4.

As shown in FIGS. 2-4, in addition to the headrail 24, valance 26, and tilt system components (e.g., tilt wand 50) described above, the headrail assembly 22 also includes one or more rail clips 100 configured to be coupled to the headrail 24. For example, as particularly shown in FIG. 3, the headrail assembly 22 includes a pair of rail clips 100 configured to be coupled to the headrail 24 such that the rail clips 100 extend across or are otherwise positioned adjacent to a front wall 70 of the headrail 24 (i.e., the wall of the headrail 24 that is configured to face the interior of the room). As will be described below, each rail clip 100 may include suitable support structure for supporting the valance 26 relative to the headrail 24. For instance, in one embodiment, the rail clips 100 may be configured to be coupled to the valance 26 via a suitable male-female connection. In such an embodiment, one of the rail clips 100 or the valance 26 may include a male connection feature (e.g., a projection or protrusion) configured to be received within a corresponding female connection feature (e.g., a slot or opening) of the other component to allow the valance 26 to be coupled to the rail clips 100.

Additionally, in accordance with aspects of the present subject matter, one or both of the rail clips 100 may also include suitable retention structure for retaining the tilt wand 50 in the stowed position relative to the headrail 24. For instance, as will be described below, the rail clip(s) 100 may, in one embodiment, define a retention feature configured to receive a portion of the tilt wand 50 when the wand 50 is moved to the stowed position. In such an embodiment, to stow away the tilt wand 50, the wand 50 may simply be pivoted upwardly about its proximal end 58 from the operating position towards the stowed position to allow a portion of the wand 50 defined between the proximal and distal ends 58, 60 of the wand 50 to be received within the retention feature of the rail clip 100. In this regard, with the tilt wand 50 received within the retention feature, the rail clip 100 may be configured to retain the tilt wand 50 at the stowed position relative to headrail 24.

It should be appreciated that, in several embodiments, the rail clips 100 may be configured to perform a dual-function by supporting/retaining both the valance 26 and the tilt wand 50 relative to the headrail 24. Specifically, the rail clips 100 may function to continuously support the valance 26 relative to the headrail 24. Additionally, when it is desired to stow away the tilt wand 50, the clips 100 may also function to retain the tilt wand 50 at the stowed position. It should also be appreciated that, although the headrail assembly 22 is shown in the illustrated embodiment as including two rail clips 100, the headrail assembly 22 may generally include any number of rail clips 100 configured to support the valance 26 and/or retain the tilt wand 50 relative to the headrail 24, such as a single rail clip or three or more rail clips.

As particularly shown in FIG. 3, when the tilt wand 50 is retained at the stowed position relative to the headrail 24 via the rail clips 100, the tilt wand 50 generally defines a substantially horizontal orientation between its proximal and distal ends 58, 60 (e.g., as opposed to the substantially vertical orientation of the tilt wand 50 when at the operating position). Additionally, in one embodiment, the tilt wand 50 may generally be configured to extend parallel to the headrail 24 when supported at the stowed position by the rail clips 100. For instance, as shown in FIG. 4, when at the stowed position, the tilt wand 50 is oriented between its proximal and distal ends 58, 60 substantially parallel to the headrail 24, such as by orienting the tilt wand 50 in the same longitudinal direction as the headrail 24 (e.g., the lateral direction L).

It should also be appreciated that, in several embodiments, the proximal end 58 of the tilt wand 50 may be configured to be coupled to be pivotably coupled to the headrail 24 via a wand connector assembly 88 of the associated tilt system 52 (FIG. 1). For instance, the wand connector assembly 88 may include suitable components for suspending the tilt wand 50 relative to the headrail 24 at the proximal end 58 of the wand 50. For instance, in one embodiment, the proximal end 58 of the wand 50 may be hooked to allow the wand 50 to be coupled to corresponding wand connector ring (not shown) of the wand connector assembly 88. In addition, the wand connector assembly 88 may include suitable components for coupling the tilt wand 50 to the tilt rod 56 (FIG. 1) of the tilt system 52. For instance, a worm gear drive and/or the like may be incorporated into the wand connector assembly 88 to allow rotation of the tilt wand 50 to be converted into corresponding rotation of the tilt rod 56.

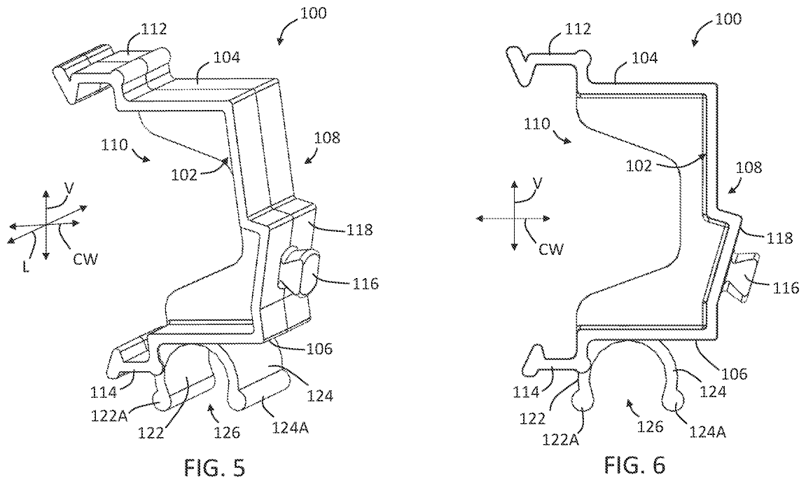

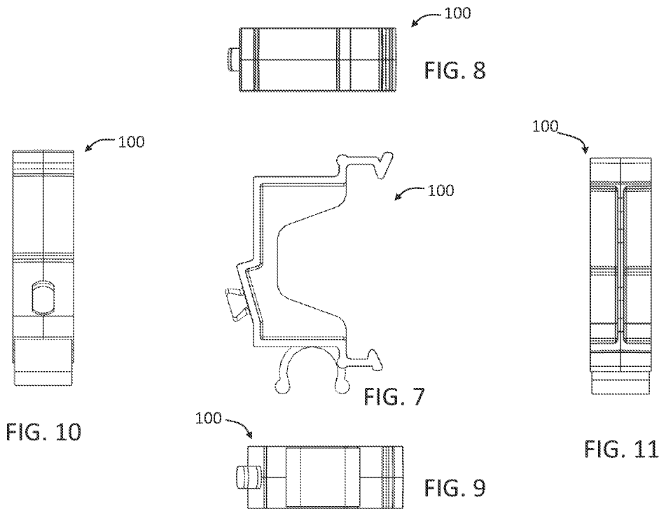

Referring now to FIGS. 5-11, several views of one embodiment of one of the rail clips 100 described above with reference to FIGS. 2-4 are illustrated in accordance with aspects of the present subject matter. Specifically, FIG. 5 illustrates a perspective view of the rail clip 100 and FIGS. 6 and 7 illustrate left and right side views, respectively, of the rail clip 100. Additionally, FIGS. 8, 9, 10, and 11 illustrate respective top, bottom, front, and rear views of the rail clip 100. It should be appreciated that, for purposes of discussion, the rail clip 100 will generally be described with reference to the headrail assembly 22 shown in FIGS. 2-4. However, in other embodiments, the rail clip 100 may be configured for use with any other suitable headrail assembly, including any other suitable headrail, valance, and/or tilt wand.

As particularly shown in FIGS. 5 and 6, the rail clip 100 generally includes a clip body 102 extending in the vertical direction (indicated by arrow V in FIGS. 5 and 6) between a top end 104 and a bottom end 106 of the body 102 and in a crosswise direction (indicated by arrow CW in FIGS. 5 and 6) between a front side 108 and a rear side 110 of the body 102. Additionally, the rail clip 100 includes a pair of connection flanges for coupling the rail clip 100 to a corresponding headrail (e.g., the headrail 24 shown in FIGS. 2-4. Specifically, as shown in the illustrated embodiment, the rail clip 100 includes upper and lower connection flanges 112, 114 positioned at the top and bottom ends 104, 106, respectively, of the clip body 102 that extend outwardly from the rear side 110 of the body 102. In such an embodiment, the connection flanges 112, 114 may be configured to wrap around or otherwise engage corresponding features of the headrail 24 to allow the rail clip 100 to be coupled thereto.

For instance, referring briefly back to the embodiment of the headrail assembly 22 shown in FIG. 4, the upper connection flange 112 may, in one embodiment, be configured to wrap around or otherwise engage a top edge 72 of the front wall 70 of the headrail 24, while the lower connection flange 114 may be configured to wrap around or otherwise engage a bottom edge 74 of the front wall 70 of the headrail 24. In such an embodiment, the rail clip 100 may, for example, be configured to be snapped onto the headrail 24 by pressing the clip 100 into the headrail 24 such that the upper and lower connection flanges 112, 114 snap over the top and bottom edges 72, 74, respectively, of the front wall 70 of the headrail 24. In this regard, the connection flanges 112, 114 may be configured to be flexible or resilient to allow for the snap-fit connection between the rail clip 100 and the headrail 24. Alternatively, the rail clip 100 may be configured to be installed at one of the lateral ends of the headrail 24 and subsequently slid along the length of the headrail 24 to the desired lateral position.

Referring back to FIGS. 5 and 6, the rail clip 100 also includes support structure for supporting a valance (e.g., the valance 26 shown in FIGS. 2-4) relative to the clip 100 (and, thus, the headrail 24 to which the clip 100 is coupled). As indicated above, in several embodiments, the rail clip 100 may be configured to be coupled to the valance 26 via a suitable male-female connection. For example, as particularly shown in FIGS. 5 and 6, the rail clip 100 includes a male connection feature (e.g., a clip projection 116, such as a dovetail-shaped projection) extending outwardly from the front side 108 of the clip body 102. In such an embodiment, the clip projection 116 may be configured to be received within a corresponding female connection feature of the valance 26 to allow the components to be coupled to each other.

For instance, referring briefly back to the embodiment of the headrail assembly 22 shown in FIG. 4, the clip projection 116 may be configured to be received within a corresponding channel or slot 80 (e.g., a dovetail-shaped slot) defined between angled wall projections 82, 84 extending outwardly from a rear face or side 86 of the valance 26 (e.g., the side of the valance 26 that faces towards the front wall 70 of the headrail 24). In such an embodiment, the rail clip 100 may, for example, be configured to be installed relative to the valance 26 by inserting the clip projection 116 into the valance slot 80 at one of the lateral ends of the valance 26 and by subsequently sliding the rail clip 100 relative to the valance 26 (or the valance 26 relative to the rail clip 100) to position the rail clip 100 at a desired location along the length of the valance slot 80. Alternatively, a snap-fit connection may be achieved by pressing the rail clip 100 against the valance 26 (or vice versa) such that clip projection 116 snaps into the valance slot 80. In this regard, the angled wall projections 82, 84 defining the valance slot 80 may, for example, be configured to be flexible or resilient to allow for the snap-fit connection between the rail clip 100 and the valance 26. It should be appreciated that, in other embodiments, the male-female connection arrangement may be reversed such that the valance 26 includes a male connection feature configured to be received within a corresponding female connection feature of the rail clip 100.

It should also be appreciated that, in one embodiment, the connection interface defined between the rail clip 100 and the valance 26 may be skewed or angled relative to the vertical direction V. For example, as shown in FIG. 4, the clip projection 116 extends outwardly from a skewed face 118 defined along the front side 108 of the clip body 102 that is angled relative to the vertical direction V (e.g., at skew angle 120). Such a skewed connection interface may allow the valance 26 to be supported relative to the rail clip 100 (and, thus, relative to the headrail 24) at a corresponding non-vertical or skewed orientation, which may be desirable for aesthetic purposes.

Referring back to FIGS. 5 and 6, the rail clip 100 also includes suitable retention structure for retaining a tilt wand (e.g., the tilt wand 50 shown in FIGS. 2-4) relative to the clip 100 (and, thus, the headrail 24 to which the clip 100 is coupled) when the tilt wand 50 is moved to the stowed position. Specifically, in several embodiments, the rail clip 100 includes first and second retention arms 122, 124 extending outwardly from the bottom end 106 of the clip body 102. As shown in FIGS. 5 and 6, the retention arms 122, 124 are spaced apart from one another in the crosswise direction CW such that a retention channel 126 is defined between the arms 122, 124 for receiving the tilt wand 50. In such an embodiment, the retention channel 126 may be configured to have any suitable shape and/or configuration that allows for the tilt wand 50 to be received therein. For instance, as shown in FIGS. 5 and 6, each retention arm 122, 124 has a slightly arcuate or curved profile as it extends outwardly from the bottom end 106 of the clip body 102 to a free end 122A, 124A thereof such that the retention channel 126 defines a semi-circular or “U-shaped” cross-sectional profile. As such, when the tilt wand 50 is inserted into the retention channel 126, the retention arms 122, 124 may be configured to wrap or extend around at least a portion of the outer circumference or perimeter of the tilt wand 50 to facilitate retaining the tilt wand 50 relative to the rail clip 100.

For instance, referring briefly back to the embodiment of the headrail assembly 22 shown in FIG. 4, the tilt wand 50 may be configured to be vertically inserted into the retention channel 126 as the tilt wand 50 is pivoted upwardly from its operating position towards its stowed position. In such an embodiment, with the tilt wand 50 fully inserted into the retention channel 126, the retention arms 122, 124 may engage around the outer circumference or perimeter of the tilt wand 50. For example, the retention channel 126 may be sized such that the free ends 122A, 124A of the retention arms 122, 124 flex outwardly as the tilt wand 50 is initially being inserted into the channel 126 and subsequently move back inwardly (e.g., towards each other) to wrap around the outer circumference or perimeter of the tilt wand 50 as the wand 50 is pushed further into the retention channel 126. As such, the retention arms 122, 124 may frictionally engage the tilt wand 50 so as to retain the wand 50 within the retention channel 126.

It should be appreciated that, in other embodiments, the retention structure of the rail clip 100 may correspond to any other suitable retention means for retaining the tilt wand 50 relative to the clip 100. In one alternative embodiment, the retention structure may comprise a hook-shaped member configured to retain or support the tilt wand 50 relative to the rail clip 100. For instance, as opposed to the retention arms 122, 124 described above, a single hooked-member or arm may extend outwardly from the bottom end 106 of the clip body 102 for supporting the tilt wand 50. In another alternative embodiment, a magnet-based connection may be provided between the tilt wand 50 and the rail clip 100. In such an embodiment, the retention structure of the rail clip 100 may, for example, correspond to a magnet configured to engage an associated ferrous element of the tilt wand 50 or a ferrous element configured to engage an associated magnet of the tilt wand 50. In yet another alternative embodiment, the retention structure of the rail clip 100 may correspond to a hook and loop fastener configured to engage a corresponding hook and loop fastener provided on the tilt wand 50. In a further alternative embodiment, a prong-type snap-fit connection may be provided between the tilt wand 50 and the rail clip 100. In such an embodiment, the retention structure of the rail clip 100 may, for example, correspond to a prong element configured to be received through a corresponding opening defined through the tilt wand 50 or vice versa. In yet another alternative embodiment, a belt or strap may be used to couple the tilt wand 50 to the rail clip 100. For instance, a flexible strap or belt may be attached to one of the rail clip 100 or the tilt wand 50 that is configured to wrap around and/or engage a portion of the other component to allow the tilt wand 50 to be supported relative to the rail clip 100. In other alternative embodiments, the rail clip 100 may be configured to have any other suitable engagement feature configured to engage a corresponding portion or feature of the tilt wand 50 to allow the wand 50 to be coupled or otherwise retained relative to the rail clip 100.

Referring briefly back to FIG. 3, it should be appreciated that, since the proximal end 58 of the tilt wand 50 is coupled to the headrail (e.g., via the wand connector assembly 88 of the tilt system 52), the headrail assembly 22 may only require a single rail clip 100 to properly retain the tilt wand 50 relative to the headrail 24 in the stowed position. For instance, in the embodiment shown in FIG. 3, the right-side rail clip 100 (i.e., the clip 100 positioned closest to the distal end 60 of the wand 50) may be sufficient to retain the tilt wand 50 relative to the headrail 24 in the stowed position. In such embodiments, when it is desirable to install two or more rail clips 100 on the headrail to provide suitable support for the valance 26 along its length, such additional rail clips 100 need not also be configured to retain the tilt wand 50. For instance, in the illustrated embodiment, the left-side rail clip 100 (i.e., the clip 100 positioned closest to the proximal end 58 of the wand 50) may alternatively be configured to only support the valance 26. Specifically, in one embodiment, such clip may not include the retention structure configured to retain the tilt wand 50 (e.g., the retention arms 122, 124 and associated retention channel 126).

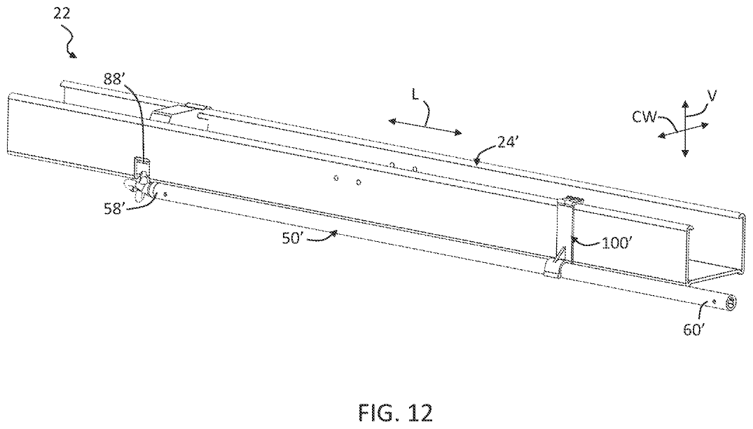

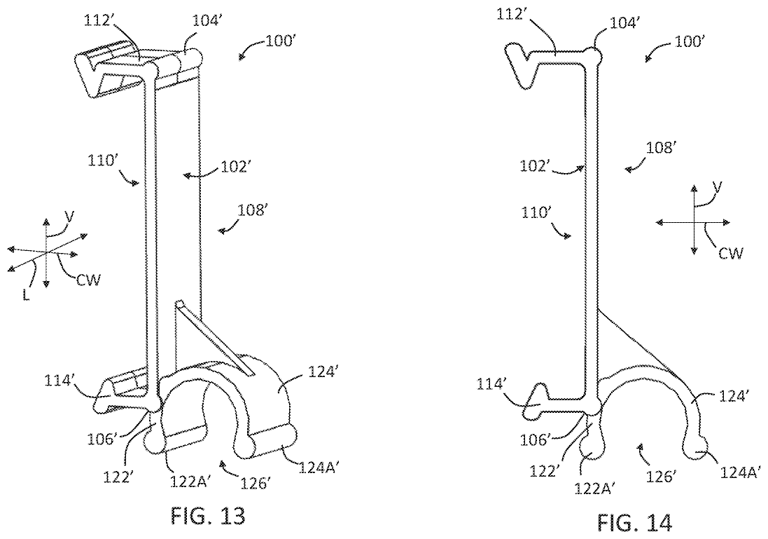

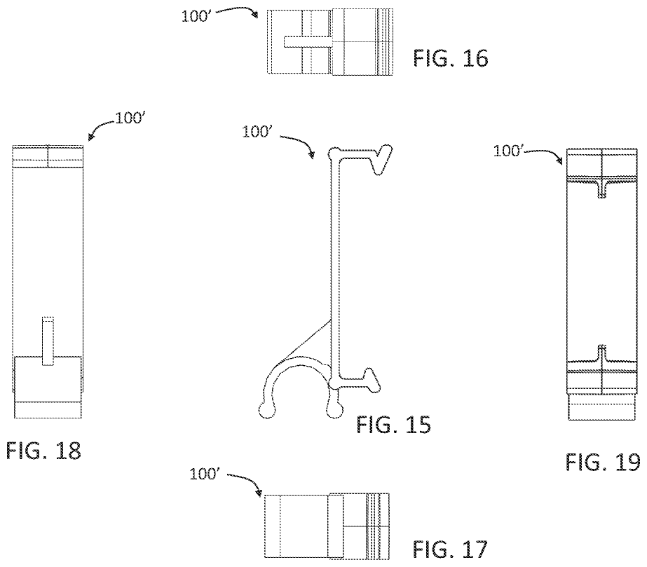

Additionally, it should be appreciated that, in alternative embodiments, the rail clips described herein may also be utilized with headrail assemblies that do not include a valance. In such embodiments, the rail clips may be configured the same as or similar to that described above with reference to FIGS. 2-11. Alternatively, the configuration of each rail clip may, for example, be modified to remove the support structure used to support the valance relative to the clip. For instance, FIGS. 12-19 illustrate different views of an alternative embodiment of a rail clip 100′ configured for use with a valance-less headrail assembly 22′ in accordance with aspects of the present subject matter. Specifically, FIG. 12 illustrates a perspective view of the rail clip 100′ coupled to a headrail 24′ of the headrail assembly 22′ while supporting a corresponding tilt wand 50′ of the assembly 22′ in a stowed position relative to the headrail 24′. FIG. 13 illustrates a perspective view of the rail clip 100′ and FIGS. 14 and 15 illustrate left and right side views, respectively, of the rail clip 100′. Additionally, FIGS. 16, 17, 18, and 19 illustrate respective top, bottom, front, and rear views of the rail clip 100′.

As particularly shown in FIGS. 13 and 14, the rail clip 100′ is generally configured similar to the rail clip 100 described above with reference to FIGS. 2-11. For instance, the rail clip 100 includes a clip body 102′ extending in the vertical direction (indicated by arrow V in FIGS. 13 and 14) between a top end 104′ and a bottom end 106′ of the body 102′ and in the crosswise direction (indicated by arrow CW in FIGS. 13 and 14) between a front side 108′ and a rear side 110′ of the body 102′. Additionally, the rail clip 100′ includes a pair of connection flanges for coupling the rail clip 100′ to a corresponding headrail (e.g., the headrail 24′ shown in FIG. 12. Specifically, as shown in the illustrated embodiment, the rail clip 100′ includes upper and lower connection flanges 112′, 114′ positioned at the top and bottom ends 104′, 106′, respectively, of the clip body 102′ that extend outwardly from the rear side 110′ of the body 102′. In such an embodiment, similar to the embodiment described above with reference to FIGS. 2-11 the upper connection flange 112′ may be configured to wrap around or otherwise engage the top edge 72′ (FIG. 12) of the front wall 70′ of the headrail 24′, while the lower connection flange 114′ may be configured to wrap around or otherwise engage the bottom edge 74′ (FIG. 12) of the front wall 70′ of the headrail 24′.

Additionally, the rail clip 100′ also includes suitable retention structure for retaining a tilt wand (e.g., the tilt wand 50′ shown in FIG. 12) relative to the clip 100′ (and, thus, the headrail 24′ to which the clip 100′ is coupled) when the tilt wand 50′ is moved to the stowed position. For instance, similar to the embodiment described above, the rail clip 100′ includes first and second retention arms 122′, 124′ extending outwardly from the bottom end 106′ of the clip body 102′ that are spaced apart from one another in the crosswise direction CW such that a retention channel 126′ is defined between the arms 122′, 124′ for receiving the tilt wand 50. In such an embodiment, the tilt wand 50′ may be configured to be vertically inserted into the retention channel 126′ as the tilt wand 50′ is pivoted upwardly from its operating position towards its stowed position. For example, the retention channel 126′ may be sized such that free ends 122A′, 124A′ (FIGS. 13 and 14) of the retention arms 122′, 124′ flex outwardly as the tilt wand 50′ is initially being inserted into the channel 126′ and subsequently move back inwardly (e.g., towards each other) to wrap around the outer circumference or perimeter of the tilt wand 50′ as the wand 50′ is pushed further into the retention channel 126′. As such, the retention arms 122′, 124′ may frictionally engage the tilt wand 50′ so as to retain the wand 50′ within the retention channel 126′. It should be appreciated that, similar to the embodiment of the rail clip 100 described above, the retention structure of the rail clip 100′ may correspond to any other suitable retention means for retaining the tilt wand 50 relative to the clip 100, such as a hook-shaped member or other engagement feature, and/or the like.

While the foregoing Detailed Description and drawings represent various embodiments, it will be understood that various additions, modifications, and substitutions may be made therein without departing from the spirit and scope of the present subject matter. Each example is provided by way of explanation without intent to limit the broad concepts of the present subject matter. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present subject matter covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present subject matter. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present subject matter being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present subject matter, and/or serve to distinguish regions of the associated elements from one another, and do not limit the associated element, particularly as to the position, orientation, or use of the present subject matter. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present subject matter. These examples are not the only way to implement these principles but are merely examples. Thus, references to elements or structures or features in the drawings must be appreciated as references to examples of embodiments of the present subject matter, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present subject matter, including the best mode, and also to enable any person skilled in the art to practice the present subject matter, including making and using any devices or systems and performing any incorporated methods. The patentable scope of the present subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

What is claimed is:

1. A headrail assembly for a covering for an architectural structure, the headrail assembly comprising:
a headrail;
a tilt wand coupled to the headrail, the tilt wand including a proximal end and a distal end spaced apart from the proximal end, the tilt wand being movable relative to the headrail between an operating position at which the tilt wand is suspended relative to the headrail at the proximal end of the tilt wand and a stowed position at which a portion of the tilt wand extending between the proximal and distal ends of the tilt wand is supported relative to the headrail; and
a rail clip configured to couple the tilt wand to the headrail when the tilt wand is at the stowed position, the rail clip including retention structure configured to retain the portion of the tilt wand relative to the headrail.

2. The headrail assembly of claim 1, wherein the retention structure is configured to engage the portion of the tilt wand at a location defined between the proximal and distal ends of the tilt wand.

3. The headrail assembly of claim 1, wherein the retention structure comprises a retention channel defined by a portion of the rail clip, the retention channel being configured to receive the portion of the tilt wand.

4. The headrail assembly of claim 3, wherein:
the rail clip comprises a clip body and first and second retention arms extending outwardly from the clip body;
the first retention arm being spaced apart from the second retention arm such that the retention channel is defined between the first and second retention arms; and
the portion of the tilt wand is configured to be inserted between the first and second retention arms and into the retention channel to allow the tilt wand to be retained at the stowed position via the rail clip.

5. The headrail assembly of claim 1, wherein the rail clip is configured to be coupled to the headrail such that the rail clip extends adjacent to a wall of the headrail.

6. The headrail assembly of claim 5, wherein the rail clip comprises an upper connection flange and a lower connection flange, the upper connection flange configured to engage a top edge of the wall of the headrail and the lower connection flange configured to engage a bottom edge of the wall of the headrail.

7. The headrail assembly of claim 1, further comprising a valance configured to be supported relative to the headrail via the rail clip.

8. The headrail assembly of claim 7, wherein one of the rail clip or the valance comprises a male connection feature configured to be received within a corresponding female connection feature of the other of the rail clip or the valance.

9. The headrail assembly of claim 8, wherein the rail clip comprises an outwardly extending clip projection configured to be received within a corresponding slot defined by the valance to couple the rail clip and the valance to each other.

10. The headrail assembly of claim 1, wherein the tilt wand has a substantially vertical orientation when at the operating position and a substantially horizontal orientation when at the stowed position, the tilt wand being pivotable relative to the headrail about its proximal end between the operating position and the stowed position.

11. The headrail assembly of claim 1, wherein the rail clip is configured to support the tilt wand relative to the headrail such that an orientation of the tilt wand is substantially parallel to the headrail when at the stowed position.

12. A covering for an architectural structure, the covering comprising:
a headrail;
a bottom rail spaced apart from the headrail;
a plurality of slats supported between the headrail and the bottom rail;
a tilt system configured to adjust a tilt angle of the plurality of slats, the tilt system comprising a tilt wand coupled to the headrail, the tilt wand including a proximal end and a distal end spaced apart from the proximal end, the tilt wand being movable relative to the headrail between an operating position at which the tilt wand is suspended relative to the headrail at the proximal end of the tilt wand and a stowed position at which a portion of the tilt wand extending between the proximal and distal ends of the tilt wand is supported relative to the headrail; and
a rail clip configured to couple the tilt wand to the headrail when the tilt wand is at the stowed position, the rail clip including retention structure configured to retain the portion of the tilt wand relative to the headrail.

13. The covering of claim 12, wherein the retention structure is configured to engage the portion of the tilt wand at a location defined between the proximal and distal ends of the tilt wand.

14. The covering of claim 12, wherein the retention structure comprises a retention channel defined by a portion of the rail clip, the retention channel being configured to receive the portion of the tilt wand.

15. The covering of claim 14, wherein:
the rail clip comprises a clip body and first and second retention arms extending outwardly from the clip body;
the first retention arm being spaced apart from the second retention arm such that the retention channel is defined between the first and second retention arms; and
the portion of the tilt wand is configured to be inserted between the first and second retention arms and into the retention channel to allow the tilt wand to be retained at the stowed position via the rail clip.

16. The covering of claim 12, wherein the rail clip is configured to be coupled to the headrail such that the rail clip extends adjacent to a wall of the headrail.

17. The covering of claim 12, further comprising a valance configured to be supported relative to the headrail via the rail clip.

18. The covering of claim 17, wherein one of the rail clip or the valance comprises a male connection feature configured to be received within a corresponding female connection feature of the other of the rail clip or the valance.

19. The covering of claim 12, wherein the tilt wand has a substantially vertical orientation when at the operating position and a substantially horizontal orientation when at the stowed position, the tilt wand being pivotable relative to the headrail about its proximal end between the operating position and the stowed position.

20. The covering of claim 12, wherein the rail clip is configured to support the tilt wand relative to the headrail such that an orientation of the tilt wand is substantially parallel to the headrail when at the stowed position.
